(19) United States
(12) Patent Application Publication
(10) Pub. No.: US 2015/0153529 A1
(43) Pub. Date: Jun. 4, 2015

(54) OPTICAL FIBER CABLES WITH POLYETHYLENE BINDER

(71) Applicant: OFS Fitel, LLC, Norcross, GA (US)

(72) Inventors: Stefan Jost, Augsburg (DE); Johannes Wolfert, Augsburg (DE)

(73) Assignee: OFS Fitel, LLC, Norcross, GA (US)

(21) Appl. No.: 14/399,196

(22) PCT Filed: Jan. 28, 2013
(86) PCT No.: PCT/US13/23366

§ 371 Date: Nov. 6, 2014

Related U.S. Application Data
(60) Provisional application No. 61/648,182, filed on May 17, 2012.

(51) Int. Cl. G02B 6/44

(52) U.S. Cl. CPC G02B 6/441; G02B 6/4479

(57) ABSTRACT

An optical fiber cable includes a bundle of a plurality of loose tubes held by a polyethylene binder. The polyethylene binder softens or melts when a hot cable sheath is applied during the cable manufacturing process. This prevents the polyethylene binder to cut into the loose tubes to cause indentations. Therefore, the resulting optical fiber cable is substantially free from indentations.

### CROSS REFERENCE TO RELATED APPLICATIONS

This application claims the benefit of U.S. provisional patent application Ser. No. 61/648,182, filed on May 17, 2012, having the title “Stranded Lose Tube Optical Fiber Cables with Polyethylene Tapes or Yarns,” which is incorporated herein by reference in its entirety.

### FIELD OF THE DISCLOSURE

The present invention relates generally to optical fiber cables, more specifically, to loose tube optical fiber cables.

### BACKGROUND

An optical fiber cable protects optical fibers inside of the cable using different components. For example, a loose tube optical fiber cable protects the optical fibers from an excessive tension by placing them inside of semi-rigid tubes. Such configuration allows the cable to stretch without stretching the fibers inside. One limitation of the loose tube cables is tendency to create indentations on the loose tubes by a binder. A polyester binder is a typical binder that grips a plurality of the loose tubes together. However, the polyester binder shrinks when a hot cable sheath is applied during a cable manufacturing process. At the same time, the hot cable sheath increases the temperature of the loose tubes at least partly above the glass transition temperature resulting in softening of the tubes. Thus, if the polyester binder grips the loose tubes too tight, the shrunk polyester binders cut into the loose tubes to cause indentations. Given this problem, there exists a need in the industry to manufacture loose tube optical fiber cables without any indentations.

### BRIEF SUMMARY OF THE INVENTION

Therefore, an objective of the present invention is to provide an optical fiber cable that is substantially free from indentations. One aspect of the present invention is directed to an optical fiber cable. The cable includes a cable core having a plurality of optical fibers, a polyethylene binder gripping the cable core to form a bundle, and a cable sheath surrounding the bundle.

Another aspect of the present invention is directed to a method of making an optical fiber cable. The method includes the steps of grouping a plurality of optical fibers together to form a cable core, binding the cable core with a polyethylene binder to form a bundle, and applying a cable sheath onto the bundle.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a perspective view of an exemplary loose tube optical fiber cable according to one embodiment of the present invention.

FIG. 2 is a cross-sectional view of the exemplary cable of FIG. 1.

FIG. 3 is a perspective view of an exemplary bundle of loose tubes according to one embodiment of the present invention.

FIG. 4 is a perspective view of an exemplary optical fiber cable according to another embodiment of the present invention.

FIG. 5 is a perspective view of an exemplary optical fiber cable according to yet another embodiment of the present invention.

FIG. 6 is a flowchart of a method of making an optical fiber cable according to one aspect of the present invention.

### DETAILED DESCRIPTION

Reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

A loose tube optical fiber cable protects optical fibers from an excessive tension by placing the fibers inside semi-rigid tubes. However, during a manufacturing process, a binder that holds those semi-rigid loose tubes shrinks when a hot cable sheath is applied to the bundled loose tubes. Because the loose tubes get soften but do not change noticeably their sizes under the same condition, the binder cuts into the loose tubes and causes indentations on the loose tubes.

Indentations may increase attenuation of the resulting cable by squeezing the loose tubes and the optical fibers within the tubes, which can result in fiber breaks due to the mechanical stress, if not immediately, than over the life time of the cable. Even if there is no measurable increase in the attenuation at the time of the manufacturing, the risk still exists. For example, damages to the loose tubes done by indentations may be realized as unexpected increase in attenuation of the cable during the cable installation or during long-term usage of the cable. If indentations are severe, the tubes may kink while handling the cable during cable end preparation for mid-span access or splicing. Such kinks may cause fibers inside the tubes to be damaged or to break.

However, such indentations can be successfully eliminated if the binder does not cut into the loose tubes when the hot cable sheath is applied. One way to prevent the binder to cut into the loose tubes is to use a binder that softens or melts when the hot cable sheath is applied.

This disclosure, along with the drawings, provides a detailed description of cables that are substantially free from indentations, along with methods of making the cable.

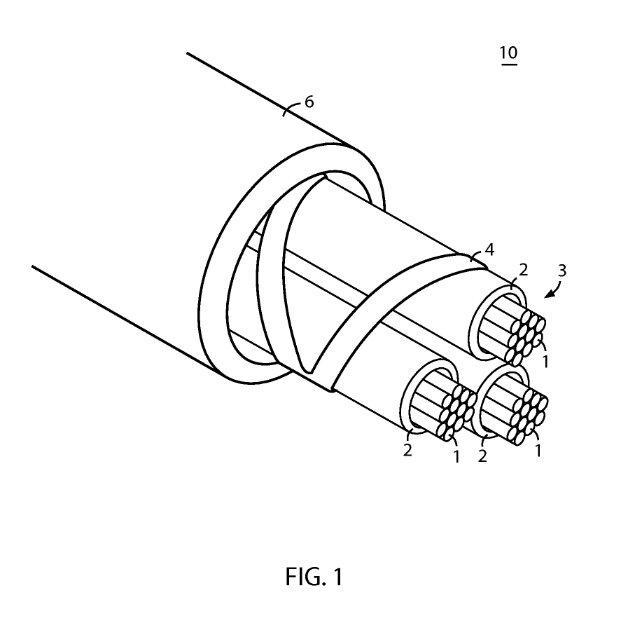

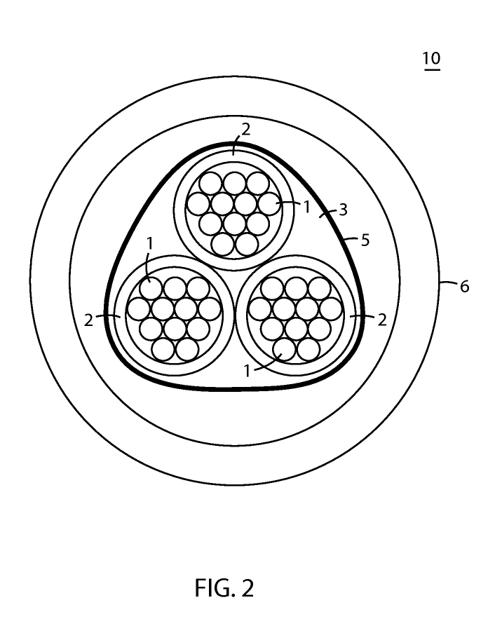

FIGS. 1 and 2 show a perspective view and a cross-sectional view of a loose tube optical fiber cable 10 according to one embodiment of the present invention. In the embodiment of FIGS. 1 and 2, the loose tube optical fiber cable 10 comprises a cable core 3, a polyethylene binder 4 that grips the cable core 3 to form a bundle 5, and a cable sheath 6 surrounding the bundle 5.

The cable core 3 includes three loose tubes 2 having twelve optical fibers 1 inside of each loose tube 2. Because the optical fibers 1 are placed inside of the semi-rigid loose tubes 2, the loose tube optical fiber cable 10 allows the cable 10 to stretch without stretching the fibers 1 inside. Such configuration protects the optical fibers 1 from an excessive tension during and after an installation. The optical fibers 1 in each loose tube 2 may be colored to aid identification of each optical fiber 1.

Because configurations of the cable core depend on the application of the cables and are well known in the industry, only limited discussion of the cable core is provided herein. However, it should be appreciated by one having ordinary skill in the art that the cable core may include different fiber types, different number of fibers per loose tube, different number of loose tubes and other components of the cable such as a ripcord. For example, the optical fibers may be single mode or multi-mode optical fibers. Each loose tube may contain two, four, five, six, eight, twelve, twenty four or more fibers, and each loose tube may contain one or more fillers. Preferably, each loose tube contains five or more fibers and fillers in combination. Most preferably, each loose tube contains six or more fibers and fillers in combination.

Referring back to FIGS. 1 and 2, the binder 4 grips the plurality of the loose tubes 2 to form the bundle 5. The binder 4 is made of polyethylene such that the binder 4 softens (not shrinks) when the hot cable sheath is applied, and preferably, the binder 4 softens at temperatures in the range of 100° C. to 140° C. The binder 4 shown in FIG. 1 is a tape that wraps around the plurality of the loose tubes 2; however, the binder 4 is not limited to the tape shape. In other embodiments, the binder 4 may be in different shape or form. For example, the binder 4 may be thread, yarn, a thin film or a tape.

The polyethylene binder 4 has advantages over a conventional polyester binder in reducing or eliminating indentations. Compare to the conventional polyester binder, the polyethylene binder 4 has three advantages. First, the polyethylene binder 4 elongates before the binder 4 cuts into the loose tubes 2. The polyethylene binder 4 is much more elastic than conventional standard yarns. Such improved elasticity in the binder 4 reduces indentations caused by a machine problem during a stranding process. When a machine problem occurs during the stranding process, some parts of the loose tubes may be held together by the binder with binding force higher than it was intended to be. Although the excessive binding force tends to squeeze the loose tubes to cause indentations, because the polyethylene binder 4 is much more elastic than conventional standard yarns, the binder 4 elongates before the binder 4 cuts into the loose tubes 2 to cause indentations. Therefore, the stranding process using the polyethylene binder 4 is less sensitive to process variations.

Second, the polyethylene binder 4 softens or melts when the hot cable sheath is applied during the cable manufacturing process. The melting point of polyethylene is lower than that of polyester. Because the temperature of the hot cable sheath applied to the bundled loose tubes is around or above the melting point of polyethylene, when the hot cable sheath is applied to the bundle 5, the polyethylene binder 4 may be melted or at least soften. This allows the bundled loose tubes 2 to get loose, instead of get tighten by a shrunk conventional polyester binder. Because the melted or softened polyethylene binder 4 does not cut into the loose tubes 2, the resulted cable 10 is free from indentations.

Third, an installer can remove the polyethylene binder 4 easier than the conventional aramid or polyester yarn during cable installation. When the installer opens a conventional optical fiber cable having aramid or polyester yarns, he needs to remove the cable sheath and aramid or polyester yarns surrounding the cable core. However because those yearns are robust materials, the installer has to cut the aramid or polyester by knifes. Such process reduces cable installation efficiency, puts unnecessary burden on the installer and adds cost. However, the installer can open the inventive cable 10 having the polyethylene binder 4 and remove the binder 4 from the cable core 3 just by hand without any tool. To enhance the accessibility to the cable core 3, a ripcord may be added between the cable core 3 and the binder 4 for easier removal of the binder 4 and the cable sheath 6.

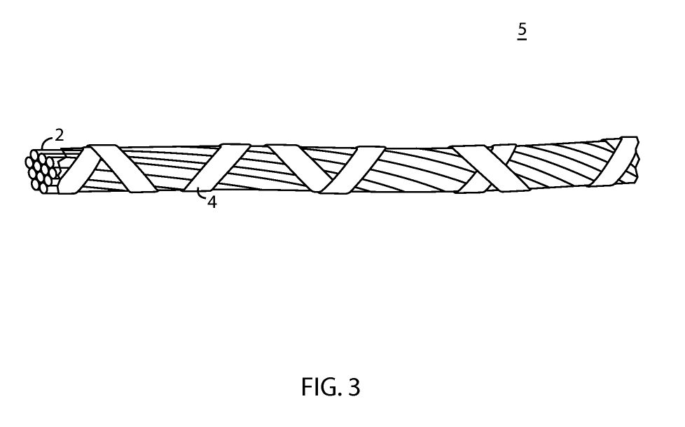

Before or during stranding process, the loose tubes 2 may be helically stranded before wrapped around by the binder 4 to form a bundle 5 as shown in FIG. 3. When the loose tubes 2 are stranded, for example, S-Z stranding or other suitable stranding methods may be used.

After the binder 4 grips loose tubes 2 together to form the bundle 5, the cable sheath 6 is applied to the bundle 5 to form the loose tube optical fiber cable 10. The cable sheath 6 can be made from various materials, but is typically made from a plastic, such as PVC. As an alternative to the PVC, the cable sheath 6 may be made from other plastics including fiber-reinforced polyethylene, a fluoro-plastic, such as PVDF, a fluoro-compound or other suitable polymeric blends. Preferably, with or without an optional ripcord, the materials for the cable sheath 6 and the binder 4 are selected such that an installer can open the optical fiber cable 10 and remove the binder 4 by installer's hands. Most preferably, the cable sheath 6 is made of polyethylene. The cable sheath 6 can also be designed to have increased flame resistance such that the optical fiber cable 10 may be rated as a riser, a plenum and/or a low smoke zero halogen. In addition, the cable sheath 6 can be designed to resist UV light, if so desired.

The present invention works well for various sizes of optical fiber cables. For example, the loose tube optical fiber cable according to the present invention may include six loose tubes having twelve optical fiber in each loose tube (i.e. 6×12 loose tube optical fiber cable), and the cable diameter may be less than 10 mm. Furthermore, because cables with relatively small loose tubes are more vulnerable to indentations, the present invention works exceptionally well for the loose tube optical fiber cables having the loose tube diameter of less than approximately 1.8 mm. In addition, the optical fiber cable may be an outside plant optical fiber cable having a water-blocking material surrounding the cable core.

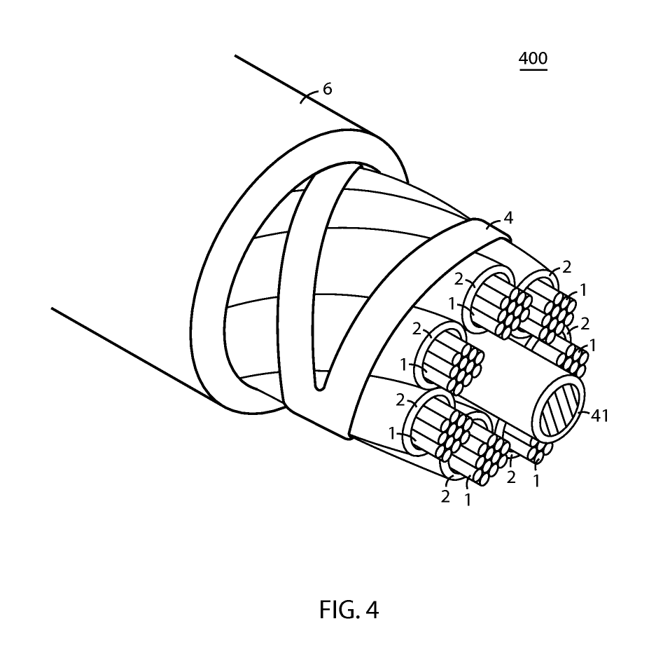

Also, a person skilled in the art can envision other embodiments of the present invention. For example, as shown in FIG. 4, the plurality of loose tubes 2 may stranded helically around a central strength element 41 to form a cable 400. Also, a cable may have multiple bundles inside the cable, and a second binder may grip those multiple bundles. Those bundles may be arranged to be helically stranded before wrapped around by the second binder.

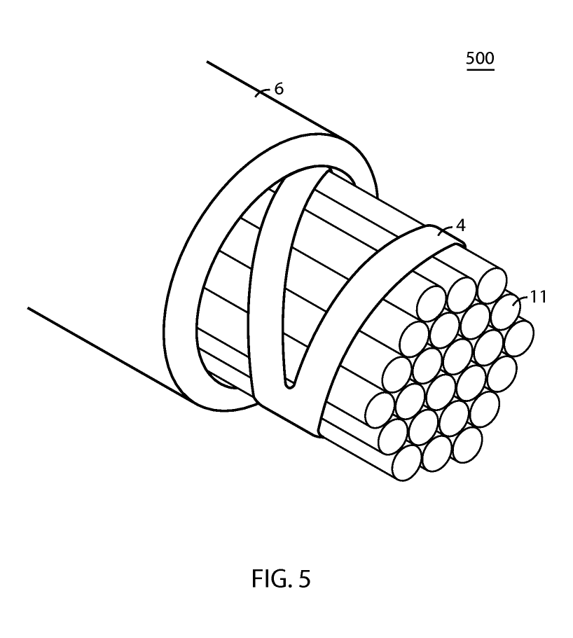

In addition, application of the polyethylene binder may equally work well for other types of cable structure. For example, the polyethylene binder 4 may be used in a buffered optical fiber cable 500 shown in FIG. 5. Because the polyethylene binder 4 does not cut into a plurality of the buffered optical fibers 11, indentations on the buffered optical fibers 11 can be substantially eliminated.

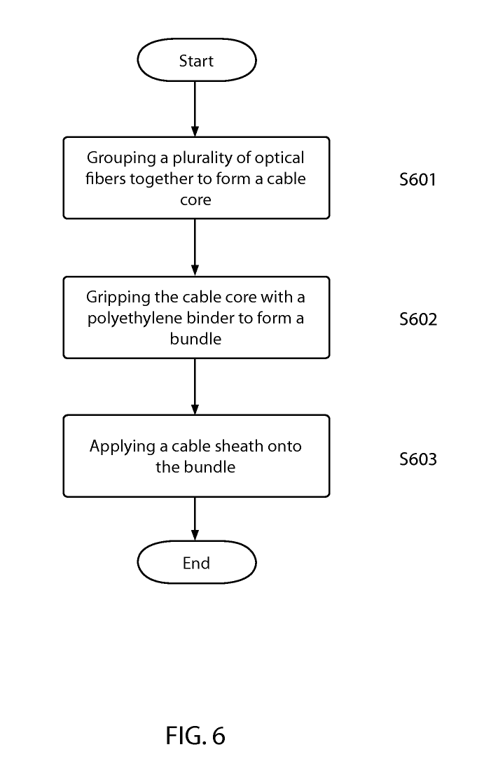

Referring now to FIG. 6, a flowchart of a method of making an optical fiber cable according to one aspect of the present invention is shown. The method comprises the following steps:
placing a plurality of optical fibers together to form a cable core (S601),
gripping the cable core with a polyethylene binder to form a bundle (S602), and
applying a cable sheath onto the bundle (S603).

In step S601, the optical fibers that form the cable core may be buffered optical fibers or the optical fibers may be contained in a plurality of loose tubes. When, the plurality of the loose tubes contains the optical fibers, a standard process is used to place the optical fibers inside each loose tube. Depending on the application of the cable, numbers of the optical fibers, and/or types of the optical fibers in each loose tube may be different. Also the optical fibers may be colored to aid identification of the optical fibers in each loose tube, and may be stranded. Furthermore, the loose tubes may contain one or more fillers.

In step S602, the cable core is gripped by a polyethylene binder to form a bundle. In the case of loose tubes, the plurality of the loose tubes may be arranged to be helically stranded before wrapped around by the polyethylene binder. When the loose tubes are stranded, for example, S-Z stranding or other suitable stranding methods may be used. The polyethylene binder may be thread, yarn, a thin film or a tape. During the stranding process, a binding force of the binder to create a bundle is less than 1000 cN to prevent unintended breaks of the binder. Preferably, a binding force of the binder is less than 800 cN.

In step S603, a cable sheath is applied onto the bundle. When the cable sheath is applied onto the bundle, the cable sheath is extruded about the bundle at the melting temperature of the cable sheath material. Typical melting temperature of the cable sheath material is more than 100° C. For example, a certain PVC material may have a melting temperature of 190° C. Because the melting temperature of the polyethylene that form the binder is less than or around the melting temperature of the cable sheath material, when the hot cable sheath material is applied to the bundle, the polyethylene binder may melt or at least softens. Because it allows the bundle to get loose, the polyethylene binder does not cut into the loose tubes or the buffered optical fibers to cause indentations. Therefore, the resulting cable form this method is substantially free from indentations.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An optical fiber cable comprising:
a cable core having a plurality of optical fibers;
a polyethylene binder gripping the cable core to form a bundle; and
a cable sheath surrounding the bundle,
whereby the optical fiber cable is substantially free from indentations.

2. The optical fiber cable according to claim 1, wherein the optical fibers are buffered optical fibers.

3. The optical fiber cable according to claim 1, wherein the plurality of the optical fibers are stored in a plurality of loose tubes to form the cable core.

4. The optical fiber cable according to claim 3, wherein the diameter of each loose tube is less than approximately 1.8 mm.

5. The optical fiber cable according to claim 3, wherein each loose tube contains twelve optical fibers.

6. The optical fiber cable according to claim 3, wherein the cable core further comprises a filler.

7. The optical fiber cable according to claim 6, wherein the sum of the optical fibers and the fillers inside each loose tube is at least five.

8. The optical fiber cable according to claim 3, wherein the optical fiber cable is a 6×12 loose tube optical fiber cable and the cable diameter is less than 10 mm.

9. The optical fiber cable according to claim 3, the plurality of loose tubes are stranded helically around a central strength element.

10. The optical fiber cable according to claim 1, wherein the polyethylene binder is a thread, yarn, thin film or tape.

11. The optical fiber cable according to claim 1, wherein the cable sheath is made of polyethylene.

12. The optical fiber cable according to claim 1, wherein the optical fiber cable is an outside plant optical fiber cable, and the cable core is surrounded by water-blocking material.

13. The optical fiber cable according to claim 1, wherein the materials for the cable sheath and the polyethylene binder are selected such that an installer can open the optical fiber cable and remove the cable sheath and the polyethylene binder by hand.

14. The optical fiber cable according to claim 13, wherein a ripcord is placed between the cable core and the polyethylene binder.

15. A method of making an optical fiber cable comprising the steps of:
grouping a plurality of optical fibers together to form a cable core;
gripping the cable core with a polyethylene binder to form a bundle; and
applying a cable sheath onto the bundle,
whereby the optical fiber cable is substantially free from indentations.

16. The method of making an optical fiber cable according to claim 15, wherein the optical fibers are buffered optical fibers.

17. The method of making an optical fiber cable according to claim 15, wherein the step of grouping a plurality of optical fibers to create a cable core further comprises a step of placing the plurality of the optical fibers inside a plurality of loose tubes, and a step of grouping the plurality of the loose tubes to form the cable core.

18. The method of making an optical fiber cable according to claim 17, wherein each loose tube contains up to twelve optical fibers.

19. The method of making an optical fiber cable according to claim 15, wherein the step of grouping a plurality of optical fibers together to form a cable core further includes a step of inserting one or more fillers to the cable core.

20. The method of making an optical fiber cable according to claim 15, wherein the temperature of the cable sheath is more than 100° C. when the cable sheath is applied to the bundle.

21. The method of making an optical fiber cable according to claim 20, wherein at least a portion of the polyethylene binder softens when the cable sheath is applied to the bundle.

22. The method of making an optical fiber cable according onto claim 20, wherein at least a portion of the polyethylene binder melts when the cable sheath is applied to the bundle.
